(19) United States
(12) Patent Application Publication
(10) Pub. No.: US 2012/0007865 A1
(43) Pub. Date: Jan. 12, 2012

(54) Image processing apparatus and method

(75) Inventors: In Woo Ha, Seoul (KR); Do Kyoon Kim, Seongnam-si (KR); Hyun Jung Shim, Seoul (KR)

(73) Assignee: SAMSUNG ELECTRONICS CO., LTD., Suwon-si (KR)

(21) Appl. No.: 13/064,619

(22) Filed: Apr. 4, 2011

(30) Foreign Application Priority Data
Jul. 6, 2010 (KR) 10-2010-0064974

(51) Int. Cl. G06T 15/50

(52) U.S. Cl. 345/426

(57) ABSTRACT

Provided is an image processing apparatus. A bidirectional reflection distribution function (BRDF) summed area table (SAT) generator of the image processing apparatus may generate a BRDF SAT of a first point using a BRDF of the first point within a three-dimensional (3D) model. A virtual area light (VAL) sampling unit of the image processing apparatus may sample a VAL corresponding to at least one point on an object of the 3D model.

### CROSS-REFERENCE TO RELATED APPLICATIONS

This application claims the priority benefit of Korean Patent Application No. 10-2010-0064974, filed on Jul. 6, 2010, in the Korean Intellectual Property Office, the disclosure of which is incorporated herein by reference.

### BACKGROUND

1. Field

Embodiments relate to global illumination rendering with respect to an object configured as a three-dimensional (3D) model, and more particularly, to sampling of a virtual light above an object in a radiosity scheme.

2. Description of the Related Art

Increasing attentions are being paid on real-time rendering with respect to a three-dimensional (3D) model. In rendering of the 3D model, a global illumination may use both a color value based on a direct illumination and a color value based on an indirect illumination.

In the case of the indirect illumination, a reflection of light, a refraction, a transmission, a scattered reflection, and the like, may be modeled on an object.

Since the indirect illumination is sampled with the direct illumination and is reflected in rendering, a variety of effects, for example, a glossy effect, a spectacular effect, a diffusing effect, and the like may be expressed, enhancing a rendering quality.

A conventional radiosity scheme for reflecting the indirect illumination in rendering has sampled a virtual point light (VPL) at a particular position within a 3D model for modeling of the indirect illumination.

However, due to characteristic of sampling, a VPL may not be disposed at an important point, or may be sampled on an unimportant outlier, which may result in limiting the rendering quality. However, an existing Monte Carlo scheme uses a relatively great amount of calculation and thus, the radiosity scheme using VPL sampling has been widely used.

### SUMMARY

In an aspect of one or more embodiments, there is provided an image processing apparatus, including: a virtual area light (VAL) sampling unit to sample a VAL corresponding to at least one point on an object of a three-dimensional (3D) model; a VAL influence calculator to calculate an influence of the VAL with respect to a first point within the 3D model; and a rendering unit to calculate a color value of the first point using the influence of the VAL using at least one processor, wherein the influence of the VAL is a weight or predetermined importance assigned to apply color values of VAL to calculation of the color value of the first point by the rendering unit.

The image processing apparatus may further include a bidirectional reflection distribution function (BRDF) summed area table (SAT) generator to generate a BRDF SAT of the first point using a BRDF of the first point.

The VAL sampling unit may sample a rectangular VAL.

The image processing apparatus may further include a BRDF SAT generator to generate a BRDF SAT of the first point by filling out a table using a cumulated function of a BRDF in which a BRDF value is cumulated with respect to each of a first axial direction and a second axial direction constituting a basis of a BRDF of the first point.

The VAL sampling unit may sample a circular VAL.

The image processing apparatus may further include a BRDF SAT generator to generate a BRDF SAT of the first point by filling out a table through calculation of a BRDF cumulated value corresponding to a number of at least one case with respect to a center point of the sampled VAL and a radius of the sampled VAL in a BRDF distribution of the first point.

When a plurality of VALs is sampled, the rendering unit may calculate, for each of the VALs, the color value of the first point using a summation of influence values of the VALs calculated by the VAL influence calculator.

When a plurality of VALs is sampled, the rendering unit may calculate, for each of the VALs, the color value of the first point using a summation of influence values of the VALs with respect to a visible area.

In an aspect of one or more embodiments, there is provided an image processing method, including: sampling a virtual area light (VAL) corresponding to at least one point on an object of a three-dimensional (3D) model; calculating an influence of the VAL with respect to a first point within the 3D model; and calculating a color value of the first point using the influence of the VAL using at least one processor, wherein the influence of the VAL is a weight or predetermined importance assigned to apply color values of VAL to calculate the color value of the first point.

In an aspect of one or more embodiments, there is provided an image processing method, including: generating a bidirectional reflection distribution function (BRDF) summed area table (SAT) within a virtual area light (VAL) corresponding to a point on an object of a three dimensional (3D) model; summing all BRDF values within the VAL; calculating an influence of the VAL using summed BRDF values within the VAL; calculating a color value of the point using the influence of the VAL using at least one processor, wherein the influence of the VAL is a weight or predetermined importance determined by the summing of all BRDF values to calculate the color value of the point.

According to another aspect of one or more embodiments, there is provided at least one non-transitory computer readable medium storing computer readable instructions to implement methods of one or more embodiments.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates an image processing apparatus according to embodiments;

FIG. 2 illustrates a process of sampling, by the image processing apparatus of FIG. 1, a virtual area light (VAL) on a three-dimensional (3D) model according to embodiments;

FIG. 3 illustrates a bidirectional reflection distribution function (BRDF) table corresponding to a point of FIG. 2 according to embodiments;

FIG. 4 illustrates a BRDF SAT generated in correspondence to a point of FIG. 2 according to embodiments;

FIG. 5 illustrates an area of a VAL of FIG. 2 positioned on the BRDF SAT of FIG. 4 according to embodiments;

FIG. 6 illustrates an area of a VAL of FIG. 2 positioned on the BRDF SAT of FIG. 4 according to embodiments;

FIG. 7 illustrates an area of a VAL of FIG. 2 positioned on the BRDF SAT of FIG. 4 according to embodiments;

FIG. 8 illustrates a process of calculating a color value of a point of FIG. 2 using the areas of FIG. 5 through 7 according to embodiments;

FIG. 9 illustrates a process of generating a SAT of a BRDF when a VAL is sampled to have a circular shape according to embodiments; and

FIG. 10 illustrates an image processing method according to embodiments.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

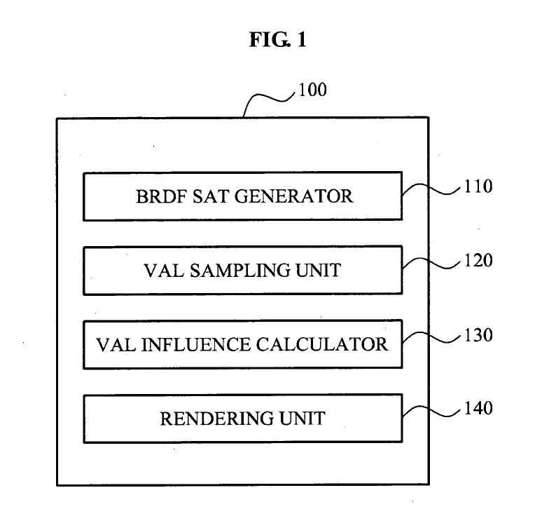

FIG. 1 illustrates an image processing apparatus 100 according to one or more embodiments.

Referring to FIG. 1, the image processing apparatus 100 may include a bidirectional reflection distribution function (BRDF) summed area table (SAT) generator 110, a virtual area light (VAL) sampling unit 120, a VAL influence calculator 130, and a rendering unit 140.

The BRDF SAT generator 110 may generate a BRDF SAT corresponding to a first point having a color value desired to be rendered.

In this example, a BRDF SAT generating process may be different depending on a shape of a VAL to be sampled by the VAL sampling unit 120.

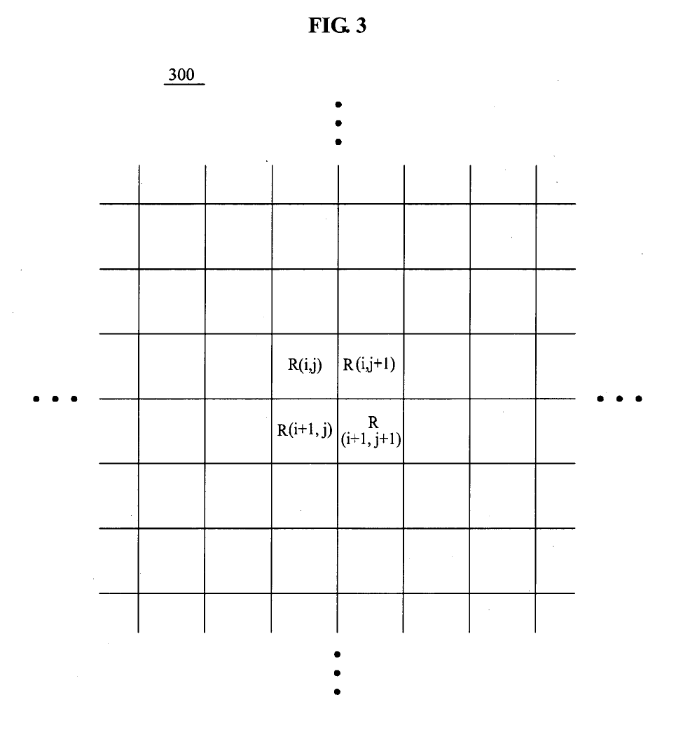

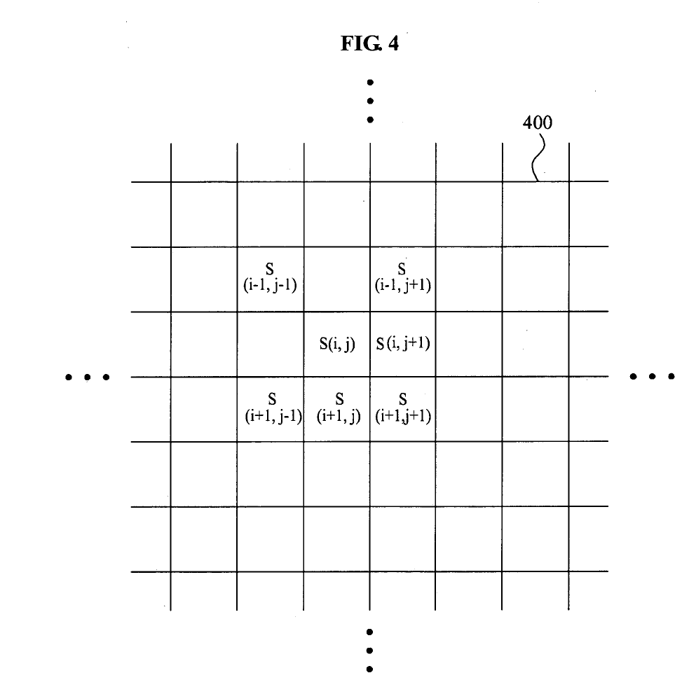

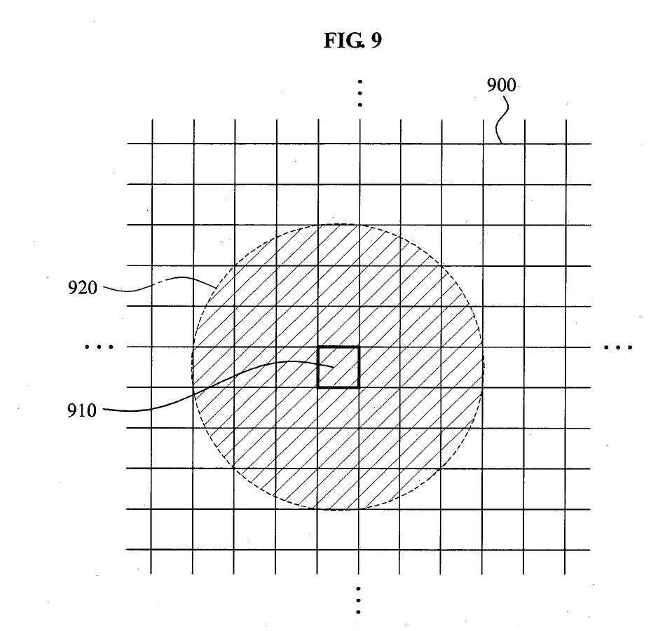

Embodiments of generating the BRDF SAT depending on the shape of the VAL to be sampled will be further described with reference to FIG. 3, FIG. 4, and FIG. 9.

The generated BRDF SAT may be used to accelerate an operation for calculating an influence of the VAL.

The VAL sampling unit 120 may sample at least one VAL on an object of a three-dimensional (3D) model.

According to one or more embodiments, a VAL having a predetermined area may be sampled as a VAL of representing a global illumination, which is different from a conventional virtual point light (VPL).

A shape or a size of a VAL may be uniformly sampled. Depending on embodiments, the shape or the size of the VAL may be adaptively sampled and/or a density of VAL sampling may also be variously modified.

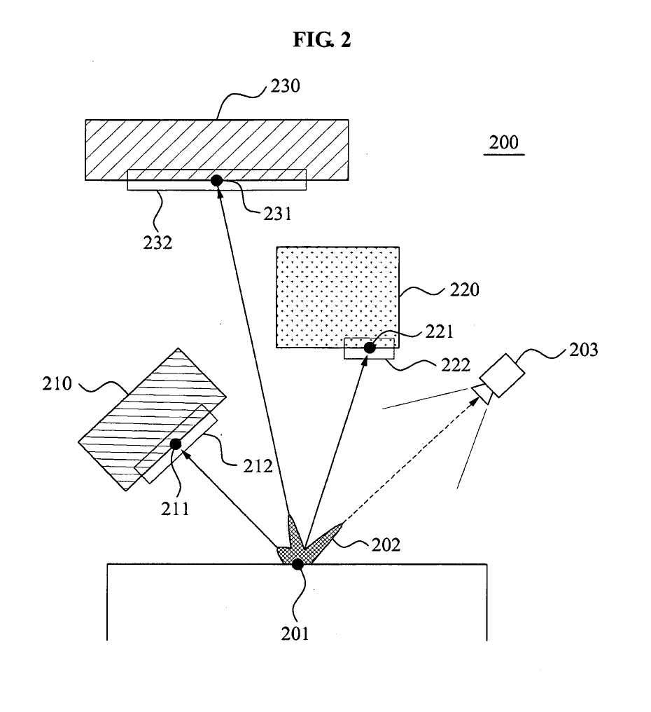

An example of VAL sampling will be further described with reference to FIG. 2.

The VAL influence calculator 130 may calculate an influence of each of sampled VALs with respect to the color value of the first point, using the generated BRDF SAT. In this process, a summation of BRDF values within a predetermined area covered by a corresponding VAL may be calculated, and an influence of reflecting a color value of the corresponding VAL in the color value of the first point may be calculated using the summation.

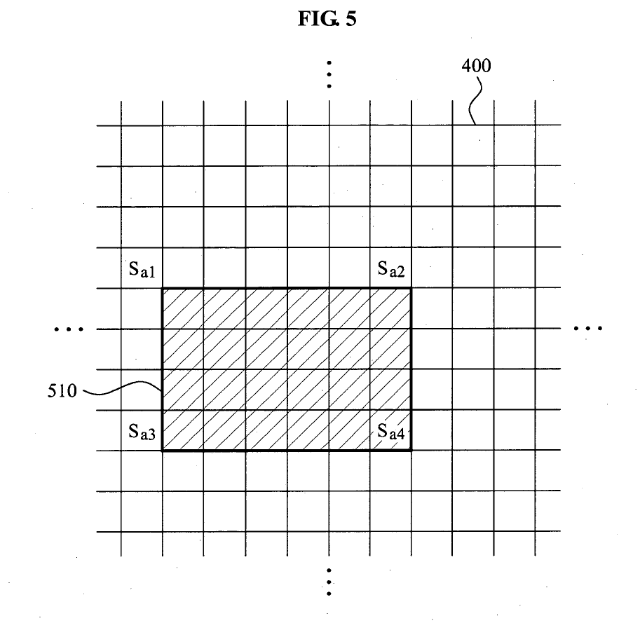

An example of calculating the summation of BRDF values within the area covered by the corresponding VAL, and calculating the influence of the corresponding VAL will be further described with reference to FIG. 5 through FIG. 8.

The rendering unit 140 may render the color value of the first point using the calculated influence of the VAL. A rendering equation may use a variety of global illumination rendering methods.

Hereinafter, an operation of the image processing apparatus 100 using a 3D model will be described.

FIG. 2 illustrates a process of sampling, by the image processing apparatus 100 of FIG. 1, a VAL on a 3D model 200 according to one or more embodiments.

Rendering using interactive global illumination may be performed to calculate a color value of a first point 201 on the 3D model 200.

The above rendering using the interactive global illumination corresponds to a scheme of calculating light, finally coming into a camera view, based on an interactive frame rate through a variety of reactive simulations, for example, a reflection of light, a refraction, and the like with respect to a given dynamic scene when a predetermined camera view and light condition is given.

For the above calculation, a BRDF may be calculated on each object point within the 3D model 200. For example, a BRDF in the first point 201 corresponds to a distribution function of light reflection to provide information regarding a progress of light reflected or diffused from the first point 201 towards a predetermined direction within a spatial area.

The BRDF may be given with respect to a hemisphere portion at a viewpoint of the first point 201. However, it is only an example and thus, may not be limitedly interpreted by a portion of BRDF embodiments. Any type of reflectivity distribution functions given for modeling of a surface characteristic may fall within the scope of this disclosure without departing from disclosed spirit of this disclosure.

FIG. 2 shows a planar BRDF 202 with respect to the first point 201. In this example, from a view of a camera 203 that is a reference viewpoint to calculate the color value of the first point 201, a relatively further protruded portion of the BRDF 202 may correspond to a portion having a relatively high reflectivity direction, and a relatively less protruded portion of the BRDF 202 corresponds to a portion having a relatively small reflectivity direction.

To calculate the color value of the first point 201 using the BRDF 202, a conventional Monte Carlo scheme may calculate an influence of each of other objects 210, 220, 230, and the like, or a real light with respect to the color value of the first point 201 through a large number of samplings.

The above scheme may use a relatively large amount of calculations and thus, may be ineffective. In addition, due to a singularity of a ray, a noisy image may be generated.

When a radiosity scheme using VPL sampling is applied, a spectacular or glossy surface may not be easily expressed.

The VAL sampling unit 120 of the image processing apparatus 100 may sample a VAL 212 in a predetermined area around a point 211 on the object 210.

This may be understood that a conventional VPL is expanded as an area light.

The VPL sampling unit 120 may sample a VPL 222 in a predetermined area around a point 221 of another object 220, and may sample a VAL 232 in a predetermined area around a point 231 of still another object 230.

During the VAL sampling process, a density of VAL sampling, an area of each VAL, and a VAL shape may be variously modified depending on embodiments.

As one example, within the 3D model 200, the VAL sampling unit 120 may sample a predetermined size of VAL to have a predetermined density regardless of object characteristic or light characteristic.

As another example, the VAL sampling unit 120 may sample different VALs based on the object characteristic or light characteristic and/or may adaptively change a VAL sampling density to be irregular.

When the VAL sampling unit 120 samples at least one VAL on the 3D model 200, the VAL influence calculator 130 may calculate a VAL influence of each of the at least one sampled VAL, for example, the VALs 221, 222, and 223 with respect to the color value of the first point 201.

In the above process, based on the BRDF 202 corresponding to the first point 201, the VAL influence calculator 130 may calculate an influence for calculation of the color value of the first point 201 to increase with respect to a VAL having a relatively great BRDF direction. The influence may be understood as a weight or a predetermined type of importance assigned to apply color values of VALs to calculation of the color value of the first point 201.

In this process, the influence calculation may be accelerated using the BRDF SAT pre-generated by the BRDF SAT generator 110.

An example of generating the BRDF SAT and calculating the color value of the first point 201 through VAL influence calculation will be further described with reference to FIG. 3.

FIG. 3 illustrates a BRDF table 300 corresponding to the first point 201 of FIG. 2 according to one or more embodiments.

For example, the BRDF table 300 may discretely express a BRDF value with respect to a hemisphere of the 3D model 200 observed from a viewpoint of the first point 201.

However, a BRDF table may be provided with respect to a portion of the hemisphere. Thus, when the BRDF table can express a surface reflection level based on each spatial direction of the first point 201, the corresponding BRDF table may be understood as the BRDF table 300 regardless of a shape, a type, and a generation method of the corresponding BRDF table.

In the BRDF table 300, R(i, j) corresponds to a BRDF value with respect to a direction of an i^{th} row and a j^{th} column. Here, i and j denote natural number. R(i, j+1) corresponds to a BRDF value with respect to the i^{th} row and a (j+1)^{th} column. In the BRDF table 300, a BRDF value with respect to each direction observed from the first point 201 is discretely expressed.

In the case of calculating a surface color value of the first point 201 by employing a global illumination, an operation of adding up BRDF values with respect to a predetermined area occupied by sampled VALs may be further used.

However, a summation of BRDF values may have an irregular result value depending on how VALs are sampled. Accordingly, when a summation of BRDF values within a predetermined area is simply calculated by calculating a cumulative function of BRDF, a total operation throughput may be significantly enhanced.

Accordingly, the BRDF SAT generator 110 may generate in advance a BRDF SAT so that calculation of a VAL influence value may be accelerated based on a shape of a VAL to be sampled.

Depending on embodiments, the sampled VAL may have a rectangular shape or a circular shape. VAL sampling having another predetermine shape may also be performed.

An example of generating a BRDF SAT and calculating a VAL influence in the case of a rectangular VAL will be further described with respect to FIG. 4 through FIG. 8, and another example of generating a BRDF SAT and calculating a VAL influence in the case of a circular VAL will be further described with respect to FIG. 9.

FIG. 4 illustrates a BRDF SAT 400 generated in correspondence to the first point 201 of FIG. 2 according to one or more embodiments.

When a VAL sampled by the VAL sampling unit 120 corresponds to a rectangular VAL, the BRDF SAT 400 may obtain a cumulated summation by cumulating a BRDF value into a row direction and a column direction of a BRDF table.

Hereinafter, descriptions are made based on a row direction and a column direction of a table, which may also be understood as obtaining of a cumulated summation into a first axial direction and a second axial direction constituting a basis with respect to a predetermined BRDF table.

For example, S(i, j) within the BRDF SAT 400 corresponds to a summation of all the BRDF table elements included in a rectangle formed by R(1, 1), R(1, j), R(i, 1), and R(i, j).

S(i+1, j+1) within the BRDF SAT 400 corresponds to a summation of all the BRDF table elements included in a rectangle formed by R(1, 1), R(1, j+1), R(i+1, 1), and R(i+1, j+1).

The BRDF SAT generator 110 may generate the BRDF SAT 400 by calculating in advance a cumulated summation. In this case, an operation of obtaining a summation of BRDF values within a rectangle VAL having a predetermined size in a predetermined position may be relatively quickly performed.

For example, within the BRDF table 400, a summation of BRDF values within a rectangle formed by R(1, 1), R(1, j+1), R(i+1, 1), and R(i+1, j+1) may be calculated according to the following Equation 1:

Summation of BRDF values=S(i+1, j+1)−S(i−1, j+1)−S(i+1, j−1)−S(i−1, j−1) [Equation 1]

In Equation 1, even though a number of left R values increases, all the BRD values within the rectangle may be immediately obtained through simple calculation of a summation and a difference if only positions of four vertexes of the rectangle are given.

By generating in advance the BRDF SAT 400 using the BRDF SAT generator 110, it is possible for the VAL influence calculator 140 to significantly accelerate an operation of calculating a summation of BRDF values within a VAL having a predetermined area.

Hereinafter, a VAL sampling process and a VAL influence calculating process will be described with reference to the example of FIG. 2.

FIG. 5 illustrates an area 510 of the 212 VAL of FIG. 2 positioned on the BRDF SAT 400 of FIG. 4 according to one or more embodiments.

The rectangular VAL 212 sampled by the VAL sampling unit 120 may cover the area 510 on the BRDF SAT 400. A summation of all the BRDF values within the area 510 may be simply calculated through an operation of a summation and a difference of four elements within the BRDF SAT 400.

For example, the summation of all the BRDF values within the area 510 may be calculated by Sₐ₄−Sₐ₂−Sₐ₃+Sₐ₁.

The summation of all the BRDF values within the area 510 may be considered as an influence of a color value of the VAL 212 with respect to calculation of the color value of the first point 201.

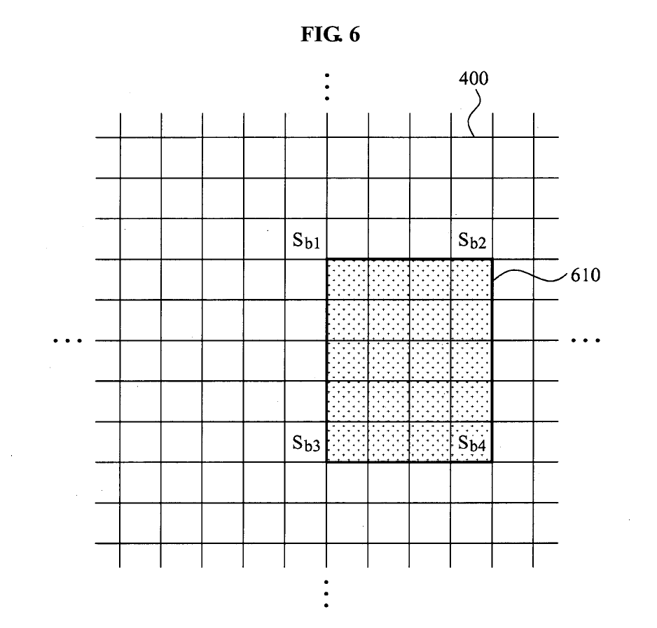

FIG. 6 illustrates an area 610 of the VAL 222 of FIG. 2 positioned on the BRDF SAT 400 of FIG. 4 according to one or more embodiments.

The rectangular VAL 222 sampled by the VAL sampling unit 120 may cover the area 610 on the BRDF SAT 400. A summation of all the BRDF values within the area 610 may be simply calculated through an operation of a summation and a difference of other four elements within the BRDF SAT 400.

For example, the summation of all the BRDF values within the area 610 may be calculated by S_{b4}−S_{b2}−S_{b3}+S_{b1}.

The summation of all the BRDF values within the area 610 may be considered as an influence of a color value of the VAL 222 with respect to calculation of the color value of the first point 201.

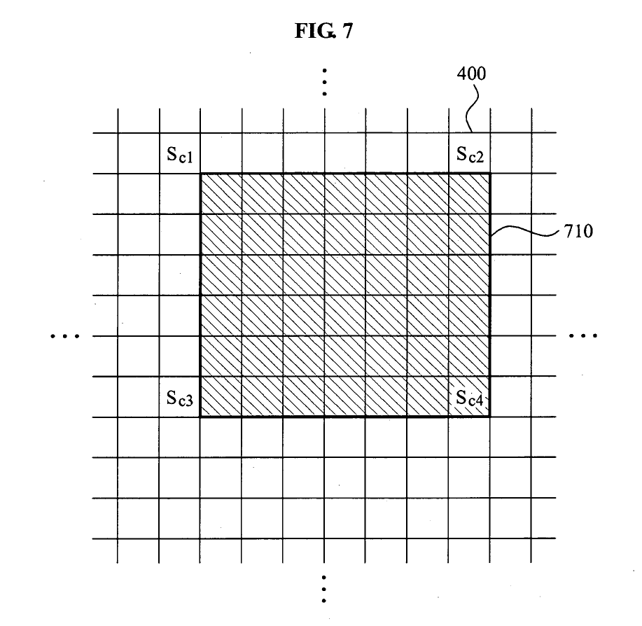

FIG. 7 illustrates an area 710 of the VAL 232 of FIG. 2 positioned on the BRDF SAT 400 of FIG. 4 according to one or more embodiments.

Similarly, a summation of all the BRDF values within the area 710 covered by the rectangular VAL 232 may be calculated by S_{c4}−S_{c2}−S_{c3}+S_{c1}.

The summation of all the BRDF values within the area 710 may be considered as an influence of a color value of the VAL 232 with respect to calculation of the color value of the first point 201.

The summation of all the BRDF values within the area 510, the summation of all the BRDF values within the area 610, and the summation of all the BRDF values within the area 710 may be independently used for calculation of the color value of the first point 201.

Instead of using a summation of BRDF values, a modified value may be used for calculation of the color value of the first point 201 based on a visibility at a first point of each VAL.

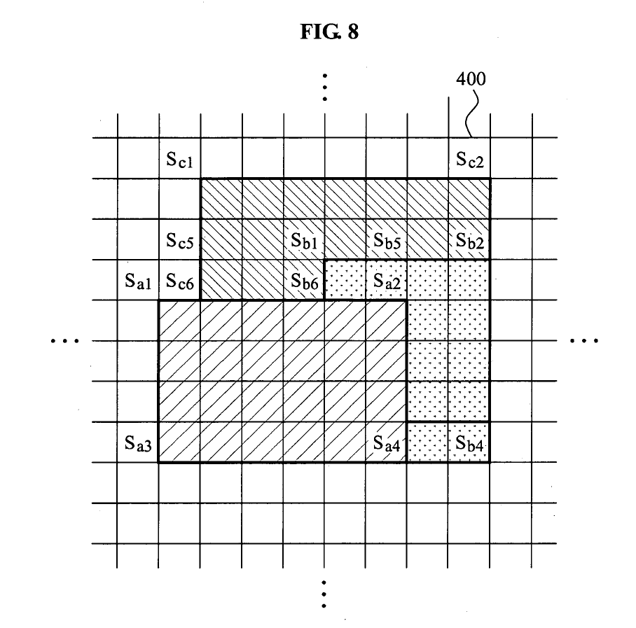

Hereinafter, the above example will be described with reference to FIG. 8.

FIG. 8 illustrates a process of calculating a color value of the first point 201 of FIG. 2 using the areas 510, 610, and 710 of FIG. 5 through 7 according to one or more embodiments.

Each of the VALs 212, 222, and 232 may have a different color value and area. Due to a spatial position of each of the objects 210, 220, and 230 where the VALs 212, 222, and 232 are sampled, a rectangle of at least one VAL may be partially occluded in the first point 210.

Influences of all the VALs may be independently used to calculate the color value of the firs point 201 by ignoring the above visibility issue. Also, the visibility may be used to calculate the color value of the first point 201.

For example, when it is assumed that the object 210 of FIG. 2 where the VAL 212 is sampled occludes a portion of the object 220 where the VAL 222 is sampled and a portion of the object 230 where the VAL 232 is sampled, and the object 220 where the VAL 222 is sampled occludes a portion of the object 230 where the VAL 232 is sampled, a visibility among the VALs 212, 222, and 232 may be shown in FIG. 8.

Accordingly, to calculate an influence of each of color values of the VALs 212, 222, and 232 with respect to calculation of the color value of the first point 201, an occluded partial area may be excluded and only a summation of BRDF values within a remaining portion may be used.

Accordingly, the influence of the VAL 212 may correspond to a summation of BRDF values calculated by (Sₐ₄−Sₐ₂−Sₐ₃+Sₐ₁), and the influence of the VAL 222 may correspond to a summation of BRDF values calculated by (S_{b4}−S_{b2}−Sₐ₄+Sₐ₂+Sₐ₂−S_{b5}−S_{b6}+S_{b1}).

Similarly, the influence of the VAL 232 may correspond to a summation of BRDF values calculated by (S_{b4}−S_{c2}−S_{c5}+S_{c1}+S_{b6}−S_{b1}−S_{c6}+S_{c5}).

An example of sampling a VAL in a rectangular shape is described above. Hereinafter, an example of sampling a VAL in a circular shape according to one or more embodiments will be described.

FIG. 9 illustrates a process of generating a SAT of a BRDF 900 when a VAL is sampled to have a circular shape according to one or more embodiments

When the VAL is sampled in the circular shape, parameters used for a summation of BRDF values may include a center point (x, y) and a radius r of the circularly sampled VAL.

Instead of using a BRDF SAT in a rectangular shape, the BRDF SAT generator 110 may generate the BRDF SAT in a separate lookup table with respect to a number of cases (x, y, r).

In general, since (x, y, r) is discretized, a finite number of cases need to be considered with respect to the first point 201. Accordingly, when a predetermined calculation is performed, the BRDF SAT may be generated in advance with respect to each (x, y, r).

For example, when a BRDF of exit angle (0 to 180 degrees, 0 to 180 degrees) with respect to a particular incident angle is expressed as a 64×64 map, a probable radius r may be 0 to 31. A number of total elements to be stored may be 64×64×32=128 k.

When the total incident angle is discretized to 64, 128 k×64=8M.

Accordingly, when center point (x, y) and the radius r are given with respect to a predetermined circular VAL, a summation result of BRDF values with respect to the above section may be obtained using table lookup.

For example, in a BRDF distribution corresponding to the first point 201 of FIG. 9, when the BRDF SAT generator 100 calculates in advance a BRDF within an area 920 having radius r=3 with respect to a center point 910 and stores the calculated BRDF in a form of a lookup table, the summation of BRDF values within the area 920 may be immediately used as necessary.

An example of simply using a summation of BRDF values within a predetermined VAL area as a VAL influence is described above.

According to other embodiments, the VAL influence calculator 130 may apply, to a rendering equation, a multiplication between a BRDF value of the first point 201 with respect to each VAL and a BRDF value of each object point within a corresponding VAL.

In this example, BRDF values of object points within each VAL as well as BRDF value of the first point 201 may be used for calculating the VAL influence. The BRDF SAT may be generated using the summation of the BRDF value of the first point 201 and the BRDF values of object points within each VAL.

Accordingly, when a predetermined level of approximation is ignored, the quality of color value calculation of the first point 201 may be enhanced.

The BRDF SAT generator 110 may generate the BRDF SAT by using a multiplication of BRDF value of the first point 201 and BRDF value of each object point within each VAL in calculating the VAL influence.

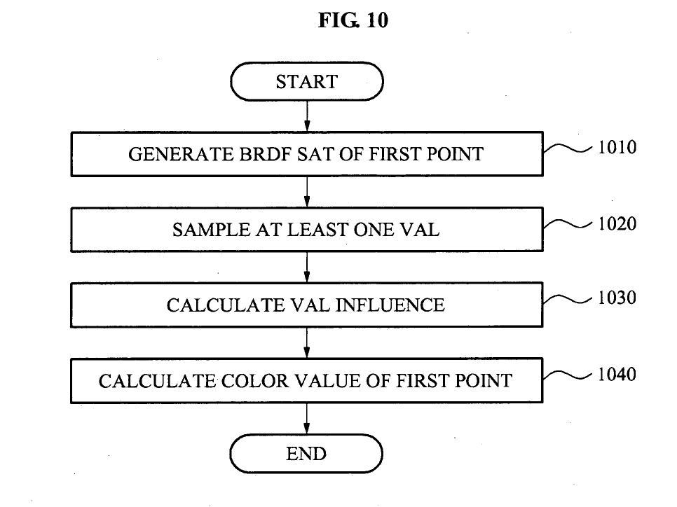

FIG. 10 illustrates an image processing method according to one or more embodiments.

In operation 1010, the BRDF SAT generator 110 may generate a BRDF SAT corresponding to a first point having a color value desired to be rendered. In this process, the BRDF SAT may be generated based on a shape of a VAL to be sampled.

The generated BRDF SAT may be used to accelerate an operation for calculating an influence of the VAL. Further description related to generation of the BRDF SAT may refer to descriptions made above with reference to FIG. 3, FIG. 4, and FIG. 9.

In operation 1020, the VAL sampling unit 120 may sample at least one VAL on an object of a 3D model.

A shape or a size of a VAL may be uniformly sampled. Depending on embodiments, the shape or the size of the VAL may be adaptively sampled and/or a density of VAL sampling may also be variously modified.

An example of VAL sampling is described above with reference to FIG. 2.

In operation 1030, the VAL influence calculator 130 may calculate an influence of each of sampled VALs with respect to a color value of the first point using the BRDF SAT. As described above with reference to FIG. 5 through FIG. 7, in this process, a summation of BRDF values within a predetermined area covered by a corresponding VAL may be calculated, and an influence of reflecting a color value of the corresponding VAL in the color value of the first point may be calculated using the summation.

In operation 1040, the rendering unit 1040 may render the color value of the first point. In this example, a rendering equation of rendering the color value of the first point using the influence value of the VAL may use a variety of global illumination rendering schemes.

According to one or more embodiments, since VAL sampling is performed instead of performing VPL sampling, it is possible to enhance an issue occurring from that due to sampling, some important object points are not considered and some unimportant object points are considered.

In a process of calculating a VAL influence, a summation of BRDF values within a predetermined area may not be individually calculated and thus, be accelerated based on a generated BRDF SAT.

The image processing method according to the above-described embodiments may be recorded in non-transitory computer-readable media including computer program instructions (computer readable instructions) to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

The non-transitory computer-readable media may also be a distributed network, so that the computer program instructions are stored and executed in a distributed fashion. The program instructions may be executed by one or more processors or processing devices. The computer-readable media may also be embodied in at least one application specific integrated circuit (ASIC) or Field Programmable Gate Array (FPGA).

Although embodiments have been shown and described, it would be appreciated by those skilled in the art that changes may be made in these embodiments without departing from the principles and spirit of the disclosure, the scope of which is defined by the claims and their equivalents.

What is claimed is:

1. An image processing apparatus, comprising:
a virtual area light (VAL) sampling unit to sample a VAL corresponding to at least one point on an object of a three-dimensional (3D) model;
a VAL influence calculator to calculate an influence of the VAL with respect to a first point within the 3D model; and
a rendering unit to calculate a color value of the first point using the influence of the VAL using at least one processor,
wherein the influence of the VAL is a weight or predetermined importance assigned to apply color values of VAL to calculation of the color value of the first point by the rendering unit.

2. The image processing apparatus of claim 1, further comprising:
a bidirectional reflection distribution function (BRDF) summed area table (SAT) generator to generate a BRDF SAT of the first point using a BRDF of the first point.

3. The image processing apparatus of claim 1, wherein the VAL sampling unit samples a rectangular VAL.

4. The image processing apparatus of claim 3, further comprising:
a bidirectional reflection distribution function (BRDF) summed area table (SAT) generator to generate a BRDF SAT of the first point by filling out a table using a cumulated function of a BRDF in which a BRDF value is cumulated with respect to each of a first axial direction and a second axial direction constituting a basis of a BRDF of the first point.

5. The image processing apparatus of claim 1, wherein the VAL sampling unit samples a circular VAL.

6. The image processing apparatus of claim 5, further comprising:
a bidirectional reflection distribution function (BRDF) summed area table (SAT) generator to generate a BRDF SAT of the first point by filling out a table through calculation of a BRDF cumulated value corresponding to a number of at least one case with respect to a center point of the sampled VAL and a radius of the sampled VAL in a BRDF distribution of the first point.

7. The image processing apparatus of claim 1, wherein when a plurality of VALs is sampled, the rendering unit calculates, for each of the VALs, the color value of the first point using a summation of influence values of the VALs calculated by the VAL influence calculator.

8. The image processing apparatus of claim 1, wherein when a plurality of VALs is sampled, the rendering unit calculates, for each of the VALs, the color value of the first point using a summation of influence values of the VALs with respect to a visible area.

9. An image processing method, comprising:
sampling a virtual area light (VAL) corresponding to at least one point on an object of a three-dimensional (3D) model;
calculating an influence of the VAL with respect to a first point within the 3D model; and
calculating a color value of the first point using the influence of the VAL using at least one processor,
wherein the influence of the VAL is a weight or predetermined importance assigned to apply color values of VAL to calculate the color value of the first point.

10. The image processing method of claim. 9, further comprising:
generating a bidirectional reflection distribution function (BRDF) summed area table (SAT) of the first point using a BRDF of the first point.

11. The image processing method of claim 9, wherein the sampled VAP is a rectangular VAL.

12. The image processing method of claim 11, further comprising:
generating a bidirectional reflection distribution function (BRDF) summed area table (SAT) of the first point by filling out a table using a cumulated function of a BRDF in which a BRDF value is cumulated with respect to each of a first axial direction and a second axial direction constituting a basis of a BRDF of the first point.

13. The image processing method of claim 9, wherein the sampled VAL is a circular VAL.

14. The image processing method of claim 13, further comprising:
generating a bidirectional reflection distribution function (BRDF) summed area table (SAT) of the first point by filling out a table through calculation of a BRDF cumulated value corresponding to a number of at least one case with respect to a center point of the sampled VAL and a radius of the sampled VAL in a BRDF distribution of the first point.

15. The image processing method of claim 9, wherein the calculating of the color value comprises calculating, for each of a plurality of VALs, the color value of the first point using a summation of influence values of the VALs, when the plurality of VALs is sampled.

16. The image processing method of claim 9, wherein the calculating of the color value comprises calculating, for each of a plurality of VALs, the color value of the first point using a summation of influence values of the VALs with respect to a visible area, when the plurality of VALs is sampled.

17. A non-transitory computer-readable medium comprising a program for instructing a computer to perform an image processing method, comprising:
sampling a virtual area light (VAL) corresponding to at least one point on an object of a three-dimensional (3D) model;
calculating an influence of the VAL with respect to a first point within the 3D model; and
calculating a color value of the first point using the influence of the VAL,
wherein the influence of the VAL is a weight or predetermined importance assigned to apply color values of VAL to calculate the color value of the first point.

18. An image processing method, comprising:
generating a bidirectional reflection distribution function (BRDF) summed area table (SAT) within a virtual area light (VAL) corresponding to a point on an object of a three dimensional (3D) model;
summing all BRDF values within the VAL;
calculating an influence of the VAL using summed BRDF values within the VAL;
calculating a color value of the point using the influence of the VAL using at least one processor,
wherein the influence of the VAL is a weight or predetermined importance determined by the summing of all BRDF values to calculate the color value of the point.

19. At least one non-transitory computer readable medium storing computer readable instructions to control at least one processor to implement the method of claim 18.
